(19) United States
(12) Patent Application Publication
(10) Pub. No.: US 2015/0326514 A1
(43) Pub. Date: Nov. 12, 2015

(54) MODULAR MESSAGING PLATFORM

(71) Applicant: Mozido, Inc., Austin, TX (US)

(72) Inventors: Michael A. Liberty, Windermere, FL (US); Mike Love, Austin, TX (US); Teri Harwood, Austin, TX (US); Aliaksandr Manusovich, Austin, TX (US)

(21) Appl. No.: 14/706,853

(22) Filed: May 7, 2015

Related U.S. Application Data
(60) Provisional application No. 61/990,987, filed on May 9, 2014.

(51) Int. Cl. H04L 12/58; G06Q 10/10

(52) U.S. Cl. CPC H04L 51/046; G06Q 10/107

(57) ABSTRACT

Embodiments are directed to providing a modular messaging platform that accommodates additional functionality modules. In one scenario, a computer system instantiates a modular messaging application that is configured to interoperate with additional functionality modules. The additional functionality modules are configured to provide additional functionality to the modular messaging application. The computer system receives an indication indicating that an additional functionality module is to be implemented within the modular messaging application. The computer system then initiates transmission of a message from the messaging application, where the message is sent using at least some of the functionality provided by the additional functionality module.

### CROSS REFERENCE TO RELATED APPLICATIONS

This application claims priority to and the benefit of U.S. Provisional Patent Application Ser. No. 61/990,987, entitled “Modular Messaging Platform, filed on May 9, 2014, which application is incorporated by reference herein in its entirety.

### BACKGROUND

Smart phones, feature phones and other mobile devices have become ubiquitous throughout the world. These phones allow users to communicate with other persons in all but the remotest locations on the globe. Users may communicate using traditional voice phone calls, or may use other, text-based communications. For instance, users may communicate using email or text messaging applications. Text messaging applications allow users to send short snippets of text using the short message service (SMS) or using other apps that allow text messages to be sent over WIFI.

### BRIEF SUMMARY

Embodiments described herein are directed to providing a modular messaging platform that accommodates additional functionality modules. In one embodiment, a computer system instantiates a modular messaging application that is configured to interoperate with additional functionality modules. The additional functionality modules are configured to provide additional functionality to the modular messaging application. The computer system receives an indication indicating that an additional functionality module is to be implemented within the modular messaging application. The computer system then initiates transmission of a message from the messaging application, where the message is sent using at least some of the functionality provided by the additional functionality module.

In another embodiment, a computer system is provided. The computer system includes at least one processor and various hardware and software components for providing a modular messaging platform that accommodates additional functionality modules. The computer system includes an application instantiating module for instantiating a modular messaging application that is configured to interoperate with additional functionality modules, where the additional functionality modules are configured to provide some portion of additional functionality to the modular messaging application. The computer system also includes a receiving module (e.g. a hardware receiver) for receiving an indication indicating that at least one additional functionality module is to be implemented within the modular messaging application. The computer system further includes a transmission initiating module (e.g. a hardware transmitter) initiating transmission of a message from the messaging application, where the message is sent using at least some of the functionality provided by the additional functionality module.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including providing a modular messaging platform that accommodates additional functionality modules.

FIG. 2 illustrates a components and deployment diagram in which embodiments described herein may operate.

FIG. 3 illustrates a flowchart of an example method for providing a modular messaging platform that accommodates additional functionality modules.

FIG. 4 illustrates an embodiment in which a user is registered with a messaging platform.

FIG. 5 illustrates an embodiment in which a user is authenticated to a messaging platform.

FIG. 6 illustrates an example embodiment of the components of a modular messaging platform.

FIGS. 7A-7H illustrate example modular messaging platform component interactions for user registration, retail messaging, adding contacts, approving contacts, retrieving contacts, deleting contacts, and uploading and managing files.

FIG. 8 illustrates example user interface wires for registering a user is with a modular messaging platform.

FIG. 9 illustrates an example user interface wire for navigating through messages within a modular messaging platform.

FIG. 10 illustrates example user interface wires for changing a user's profile settings within a modular messaging platform.

FIG. 11 illustrates example user interface wires for adding contacts within a modular messaging platform.

FIG. 12 illustrates example user interface wires for sending retail messages using a modular messaging platform.

FIG. 13 illustrates example user interface wires for conducting a group chat within a modular messaging platform.

FIG. 14 illustrates example user interface wires for sending messages within a modular messaging platform.

FIG. 15 illustrates example user interface wires for receiving offline messages within a modular messaging platform.

FIG. 16 illustrates example user interface wires for resolving lost connection issues within a modular messaging platform.

### DETAILED DESCRIPTION

Embodiments described herein are directed to providing a modular messaging platform that accommodates additional functionality modules. In one embodiment, a computer system instantiates a modular messaging application that is configured to interoperate with additional functionality modules. The additional functionality modules are configured to provide additional functionality to the modular messaging application. The computer system receives an indication indicating that an additional functionality module is to be implemented within the modular messaging application. The computer system then initiates transmission of a message from the messaging application, where the message is sent using at least some of the functionality provided by the additional functionality module.

In another embodiment, a computer system is provided. The computer system includes at least one processor and various hardware and software components for providing a modular messaging platform that accommodates additional functionality modules. The computer system includes an application instantiating module for instantiating a modular messaging application that is configured to interoperate with additional functionality modules, where the additional functionality modules are configured to provide some portion of additional functionality to the modular messaging application. The computer system also includes a receiving module (e.g. a hardware receiver) for receiving an indication indicating that at least one additional functionality module is to be implemented within the modular messaging application. The computer system further includes a transmission initiating module (e.g. a hardware transmitter) initiating transmission of a message from the messaging application, where the message is sent using at least some of the functionality provided by the additional functionality module.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

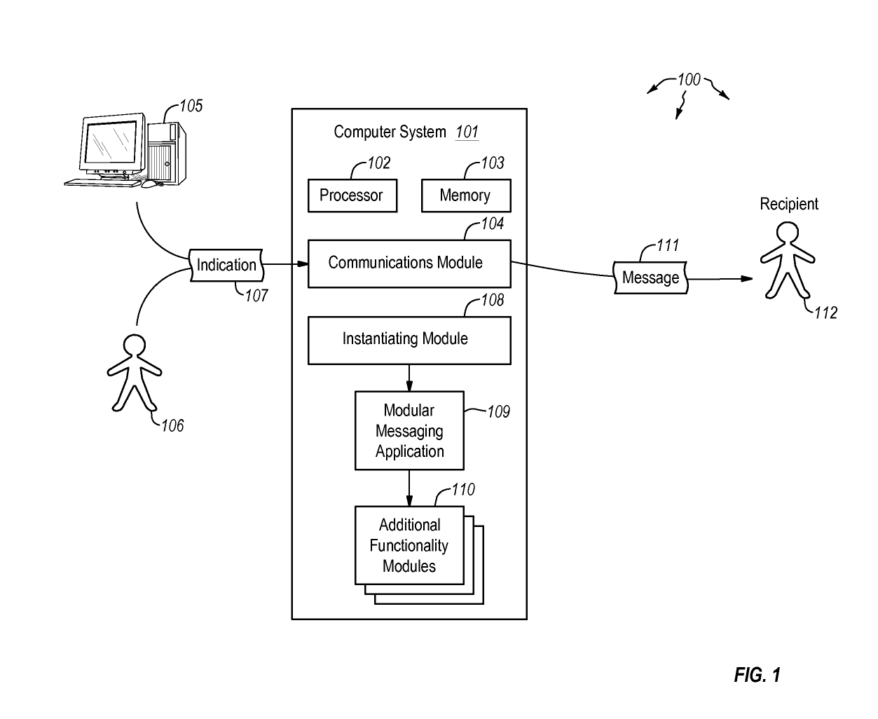

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network. Such communication channels may include hardware-based receivers, transmitters or transceivers, which are configured to receive data, transmit data or perform both.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments described herein also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, embodiments described herein may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The computing module 104 may include any wired or wireless communication means that can receive and/or transmit data to or from other computing systems. The communications module 104 may be configured to interact with databases, mobile computing devices (such as mobile phones or tablets), embedded or other types of computing systems.

The computer system 101 further includes an instantiating module 108. The instantiating module 108 may be configured to instantiate other applications or functionality modules. For instance, the instantiating module 108 may be used to instantiate modular messaging application 109. The modular messaging application 109 may be any type of messaging application that allows users to send text messages to each other. The text messages may be sent using SMS over cellular networks, or may be sent using application push messages, for example, over WIFI or other internet-connected networks. The modular messaging application 109 may be referred to as “modular” as it allows use of and implementation of other functionality modules. These functionality modules may be added to or removed from the base messaging application 109. The additional functionality modules 110 may be used to add customized and specific functionality to a messaging application.

For example, the additional functionality modules may add industry-specific functionality such as encryption, auto-persist (i.e. the automatic storage of messages), auto-destroy (i.e. automatic destruction of messages), regulation compliance, storing of metadata, appending of file attachments, designating a message as privileged, performing language translation, adding video, voice, group chat or other features or substantially any functionality that may be useful in conjunction with a messaging application.

A user 106 or other entity 105 may send an indication 107 indicating that certain portions of functionality are to be added to or used in conjunction with the modular messaging application 109. This additional functionality may be provided by the additional functionality modules 110. One or more of these modules may be used to provide the requested functionality. The requested functionality modules 110 may be stored locally on the computer system 101, or may be retrieved from another computing system such as a cloud computing system. Each message 111 sent by the modular messaging application 109 may be sent using the same or a different type of functionality or different combination of functionality types.

For instance, in one message conversation, the user may select to have metadata stored, to add attachments, and to have the message auto-persist. In another conversation with the same or a different person, the user may add video, may have the messages encrypted and may have the message comply with certain regulations. Any combination of functionality modules 110 may be used in any conversation with any recipient. The recipient 112 may receive these messages and reply to them within the same parameters as they were sent by the messaging application 109.

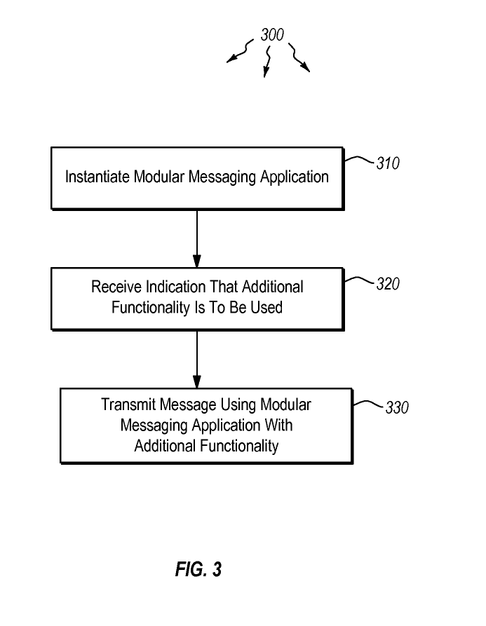

In some embodiments, a computer program product is provided for implementing a method (e.g. Method 300 of FIG. 3) for providing a modular messaging platform that accommodates additional functionality modules. The computer program product may include computer-readable storage media having stored thereon computer-executable instructions that, when executed by processors of a computing system, cause the computing system to perform the method. The method 300 includes instantiating a modular messaging application 109 that is configured to interoperate with one or more additional functionality modules 110, where the additional functionality modules is configured to provide some portion of additional functionality to the modular messaging application (310). The method further includes receiving an indication 107 indicating that at least one specified additional functionality module 110 is to be implemented within the modular messaging application 109 (320) and, further, initiating transmission of a message 111 from the messaging application, where the message is sent using at least a portion of the functionality provided by the additional functionality modules (330).

The instantiating module 108 of computer system 101 may thus instantiate modular messaging application 109 and use it to send messages in a customized manner. The modular messaging application 109 may provide the customized message delivery using the additional functionality modules 110 that each provide different types of functionality. In this manner, the modular messaging application 109 itself may be added to other applications in a modular form and the functionality modules 110 may be added to the modular messaging application 109 when it is part of the other application. In this manner, the modular messaging application 109 may add messaging functionality to existing applications, and the functionality modules 110 may be added to the modular messaging application 109 to add functionality to the modular messaging application.

As mentioned above, the types of functionality that may be added to the modular messaging application 109 may include any portions of functionality that could be used in combination with a messaging application. Functions such as encryption may be implemented in order to encrypt outgoing messages 111. Thus, additional functionality modules 110 may include an encryption module that uses one or more of a variety of different encryption algorithms to encrypt and/or decrypt the messages 111 sent by the messaging application. Other functionality may include attaching files. In such cases, the additional functionality modules 110 would include a file attachment module that allows files such as documents, pictures or videos to be attached to a text message 111.

Still further, the additional functionality modules 110 may include an auto-persist or an auto-destroy module that causes messages to be automatically stored in a local or distributed data store, or causes messages to be automatically destroyed upon being viewed by the recipient 112. Such functionality may be part of a policy, or may be part of another functionality module such as one that forces compliance with one or more regulations. For instance, the modular messaging application 109 may determine that, based on the recipient 112, the user 106 is messaging their lawyer. This could in turn trigger an additional functionality module 110 that ensures that the messages remain privileged by automatically destroying the message and/or not storing the message and/or marking the message with a “privileged” tag.

Similarly, the user may indicate or the messaging application 109 may determine that the recipient is a doctor or other healthcare professional. Those communications may be regulated by the Health Insurance Portability and Accountability Act (HIPAA). As such, the additional functionality modules may automatically encrypt and persist messages (or certain parts of them such as metadata). Accordingly, it will be understood that the additional functionality modules 110 may add functionality to a messaging application, which itself is modular and may be added to other applications to provide messaging functionality.

In some cases, the functionality provided by modules 110 may be dormant until triggered by one or more specified actions. For instance, functionality may be provided to allow messages to be decrypted upon receiving an encrypted message, or functionality may be provided that translates from one language to another upon the user selecting a translate button or upon the messaging application determining that a message was received in another language. In some cases, a user may mark a message or conversation as “privileged” in which case the messages of the conversation will be automatically destroyed upon completion of the conversation. The additional functionality of modules 110 may be applied according to policy.

Thus, if policy dictates that certain messages be encrypted based on their content or based on the recipient or based on some other determination, the policy will activate the additional functionality to encrypt the message. Many different policies may be used singly or in combination to ensure that messages are transmitted and received as desired. These policies may be stored on a local device (such as a mobile device used by user 106) or on a database or other computer system (e.g. 101).

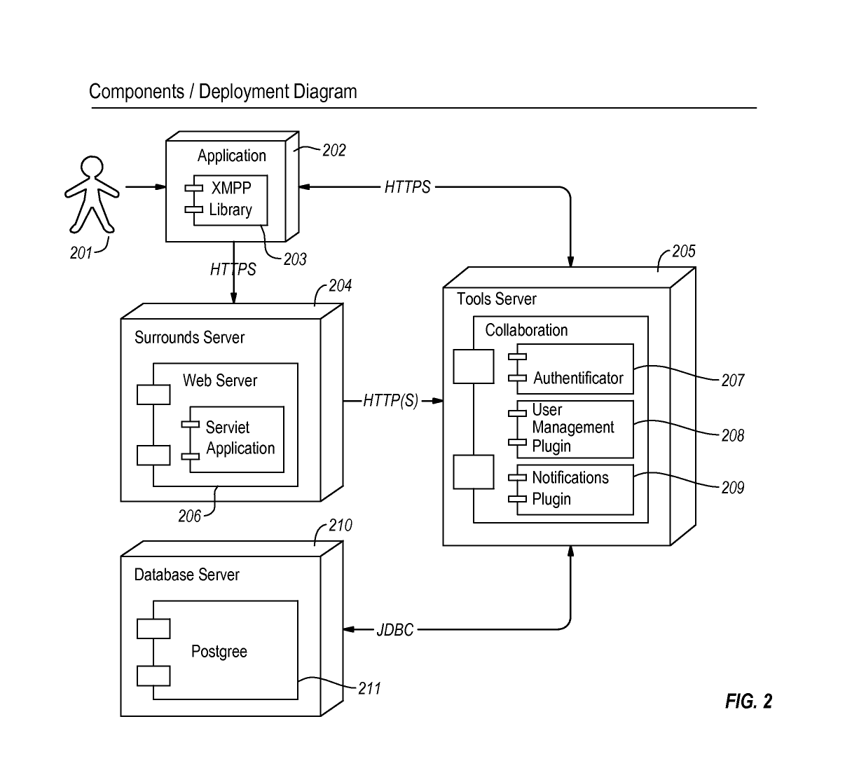

The modular messaging application 109 may be structured to access other applications and servers. For example, as shown in FIG. 2, the application 202 may implement the Extensible Messaging and Presence Protocol (XMPP) protocol (or another protocol) in order to transmit and receive messages to and from various different servers. For instance, the XMPP library 203 may use the hyper-text transfer protocol secure (HTTPS) protocol to communicate with surrounds server 204. The surrounds server 204 may include a servlet application 206 that includes the additional functionality modules 110 that can be added to the messaging application 202.

The application 202 and server 204 may communicate with a tools server 205 which includes collaboration modules including an authenticator 207 (used to authenticate user 106 and/or recipient 112 of FIG. 1), a user management plug-in 208 that may include message transmission policies, and a notifications plug-in 209 that notifies users when message have been sent/received, and when transmission/receive errors have occurred. The tools server 205 may be configured to communicate with a database server 210 that uses PostgreSQL 211 or some other object-relational database management system (ORDBMS) or other type of database management system to organize and access stored information. This architecture is just one embodiment of many different potential computing architectures in which a modular messaging platform may be provided that accommodates additional functionality modules.

Returning to FIG. 1, in some embodiments, the modular messaging application 109 may include business functionality layers. These business functionality layers may each comprise additional functionality modules. A business functionality layer may include a set of functionality that is desirable to or useful to a given business or other entity. Each business functionality layer may include one or multiple different pieces of functionality. Thus, for example, a business may have one business functionality layer for people in shipping and handling, another business functionality layer for people in human resources, another for people in management, and another for the general workforce. Each business layer may include some or all of the same pieces of functionality, or may include unique pieces of functionality. Accordingly, one modular messaging application may have different business functionality layers, each of which provides different functionality modules 110 to the users that are part of that business layer.

As each business functionality layer allows different types or forms of functionally, it will be further noted that the functionality for each business functionality layer is user-customizable. Accordingly, users may customize which business layers are to be used in conjunction with the messaging application 109, and users may further customize the functionality provided by the additional functionality modules 110 in each business functionality layer. In this manner, a user or entity may have total control over which functions are available within the messaging application for different persons or groups of people. Designations of which functions are available for which people may be governed according to policies established by user 106 or other entity 105. Indeed, in some cases, a user may opt to have multiple different business functionality layers implemented on top of the messaging application in combinations specified by the user.

These business functionality layers may be industry-specific and, as such, may be valuable to multiple businesses of a given type. For example, some portions of functionality (e.g. encryption) may be useful and/or required in the healthcare industry. The ability to auto-destroy a message or conversation may be useful in the legal industry. The ability to auto-persist a message or conversation may be useful in the financial industry. As will be apparent to one skilled in the art, different types of functionality may be more or less useful in different industries, and may be applied differently to modular messaging application 109 in each industry.

In some embodiments, industry-specific business functionality layers may include industry-specific additional functionality modules that include pre-generated instructions that may be added to the modular messaging application. These pre-generated instructions may include a series of processing steps that are performed on a message 111 before it is transmitted and/or at reception from another user.

In some cases, these industry-specific business functionality layers may be configurable to ensure compliance with industry-specific regulatory requirements (e.g. HIPAA) or other legal, accounting or similar requirements. Regulatory requirements may require that certain messages be encrypted and/or stored for a specified period of time. Other regulatory requirements may require that metadata be stored for each message and/or messaging conversation. The metadata may be gathered at the transmission and receipt of each message and may list certain facts about the message including who sent it, to whom it was sent, the time it was sent/received, whether it was viewed, what types of additional functionality (e.g. encryption) were used to process the message, etc.

In some cases, the modular messaging application 109 is configured to (only) store metadata about the message, and that metadata may be stored locally on the user's mobile device, or may be transmitted to another data store. In such cases, the actual content of the message is not stored on the mobile device or elsewhere. The content of the message may, however, be stored in a cloud or other data store, and can be made available if necessary and if applicable guidelines have been followed.

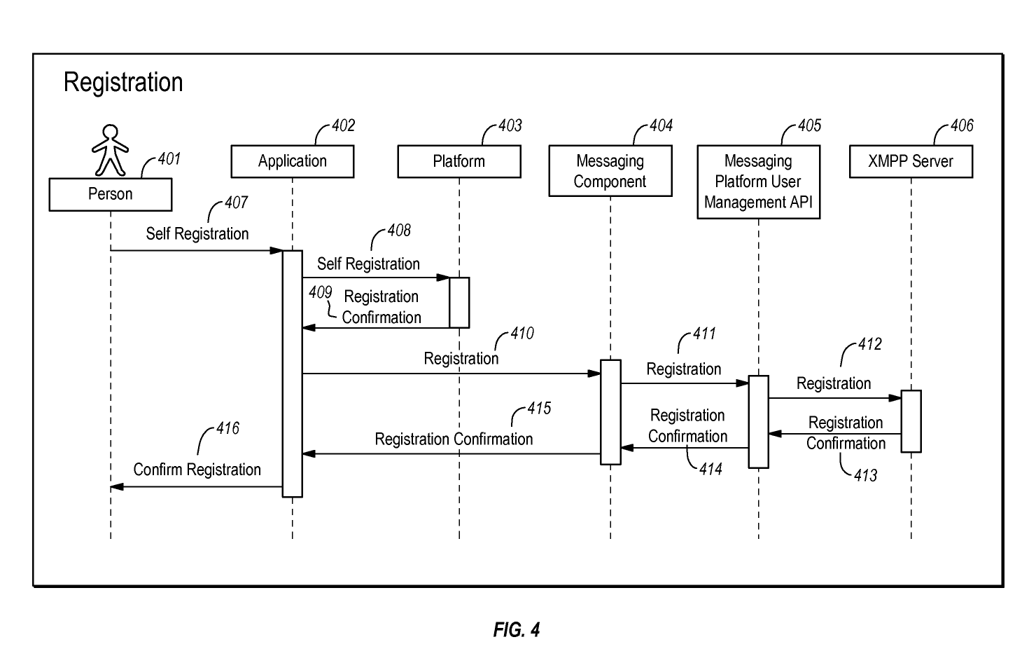

Turning now to FIG. 4, a sequence diagram is shown for registering a user on a modular messaging platform (such as that shown in FIG. 1). A person or user 401 may initiate the registration process at 407 by providing an indication of such to an application (e.g. by touching a “register” button within an application 402). The registration indication 408 may be sent to a messaging platform component that conforms the registration as needed in step 409. The application 402 then sends the registration to a messaging component 404 in step 410. The registration is then sent to a messaging platform user management API 405 in step 411 and is further sent to a messaging server such as an XMPP server 406 in step 412. The XMPP server 406 may then confirm the registration of the user 401 in step 413 assuming the correct inputs have been provided. The messaging platform user management API 405 may then send the registration confirmation to the messaging component 404 at step 414. The messaging component 404 then sends the registration confirmation to the application 402 in step 415, and the application 402 provides the registration confirmation 416 to the user 401 at step 416.

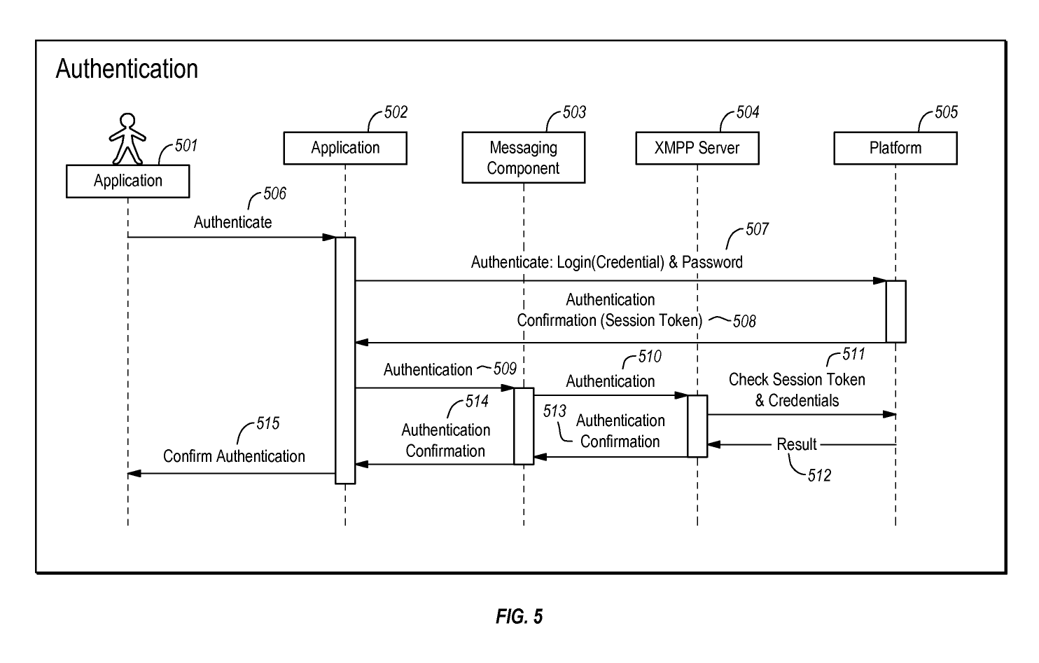

FIG. 5 illustrates a sequence diagram for authenticating a user on a modular messaging platform. As in FIG. 4, the user 501 of FIG. 5 may provide an indication to the application 502 (e.g. by touching an “authenticate” button within an application) that the user wishes to authenticate to the messaging platform. The application 502 may send the login credentials including a username and password and/or biometric or other credentials to the platform 505 in step 507. If proper credentials are provided, the platform establishes an authenticated session and sends a confirmation session token to the application 502 in step 508. The application may then send an indication to the messaging component 503 in step 509, when sends the indication to the XMPP server 504 in step 510, which checks the session token and credential with the messaging platform 505 in step 511. The messaging platform 505 then sends the result of the authentication (confirmation or denial) to the XMPP server 504 in step 512. The XMPP server 504 then sends the authentication result to the messaging component 503 in step 513, which sends the result to the application 502 in step 514, which then provides the result to the user 501 in step 515.

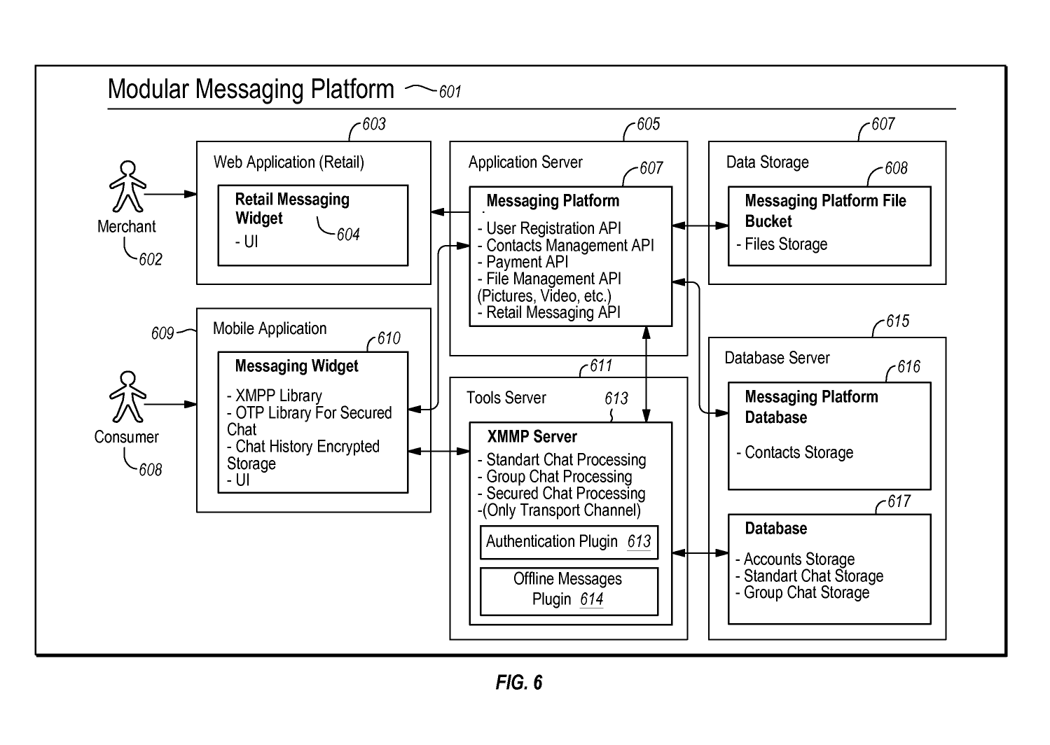

FIG. 6 illustrates an embodiment of a modular messaging platform components diagram. The modular messaging platform 601 includes a merchant 602. The merchant 602 may interact with a retail web application 603 that includes one or more retail messaging components 604 such as a user interface (UI). The web application 603 may interact with an application server 605 on which one or more modular messaging platform components 606 are operating. These components may include user registration APIs, contact management APIs, payments APIs, file management APIs (that allow attachment of pictures, videos, etc. to messages), retail messaging APIs or any other functionality modules (e.g. 110 from FIG. 1) such as encryption APIs, auto-persist or auto-destruct APIs or similar. The modular messaging platform 606 may interact with cloud (or local) data storage 607, tools server 611, database server 615 and other mobile applications 609.

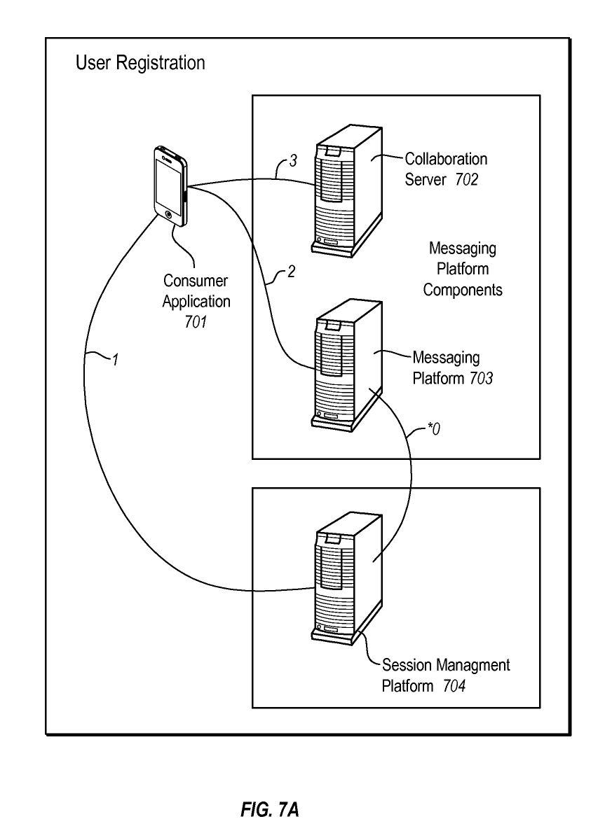

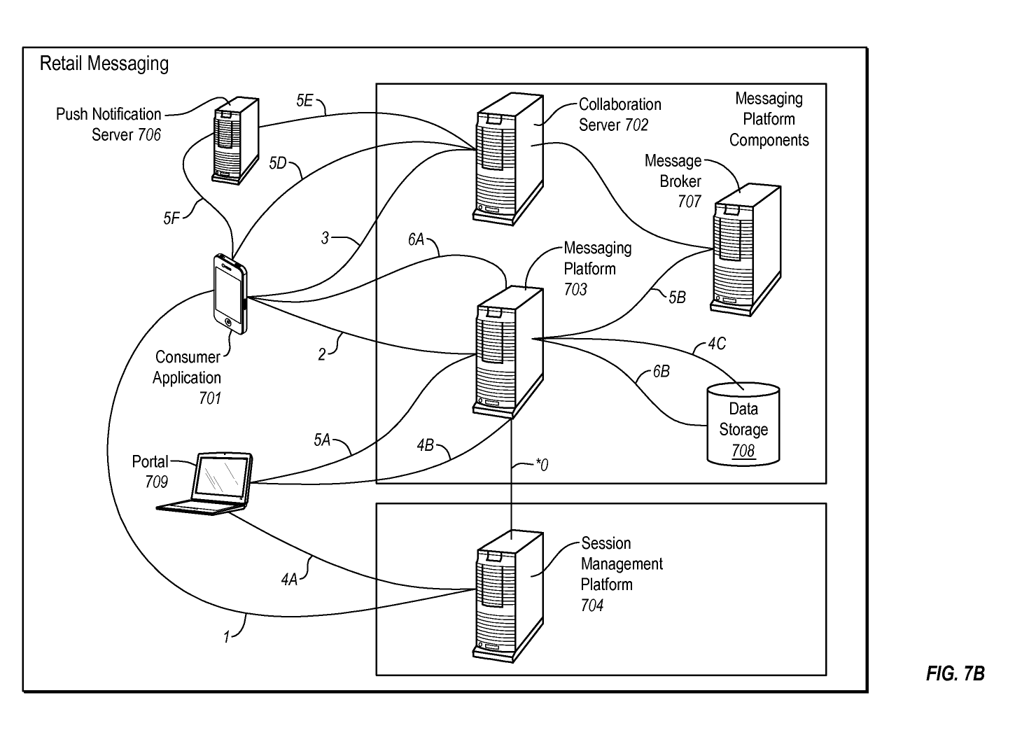

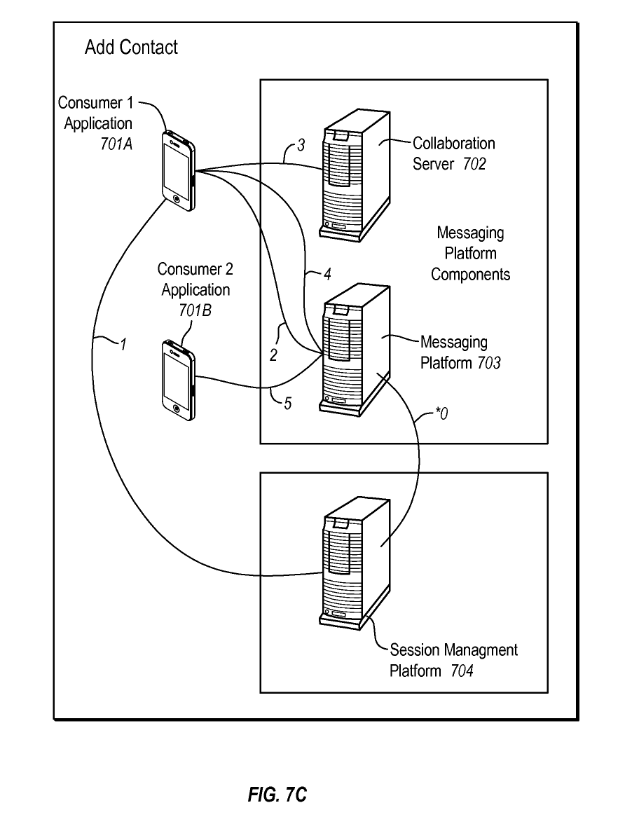

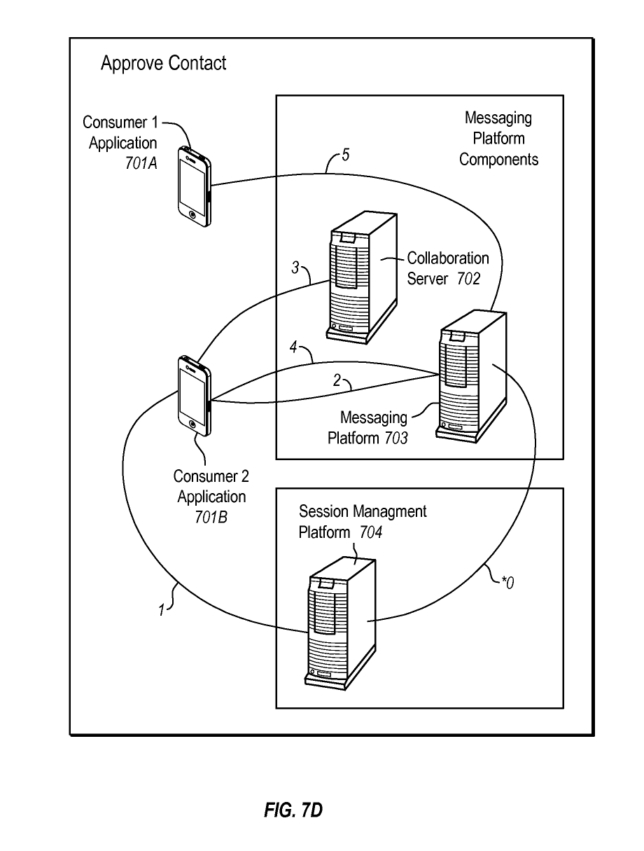

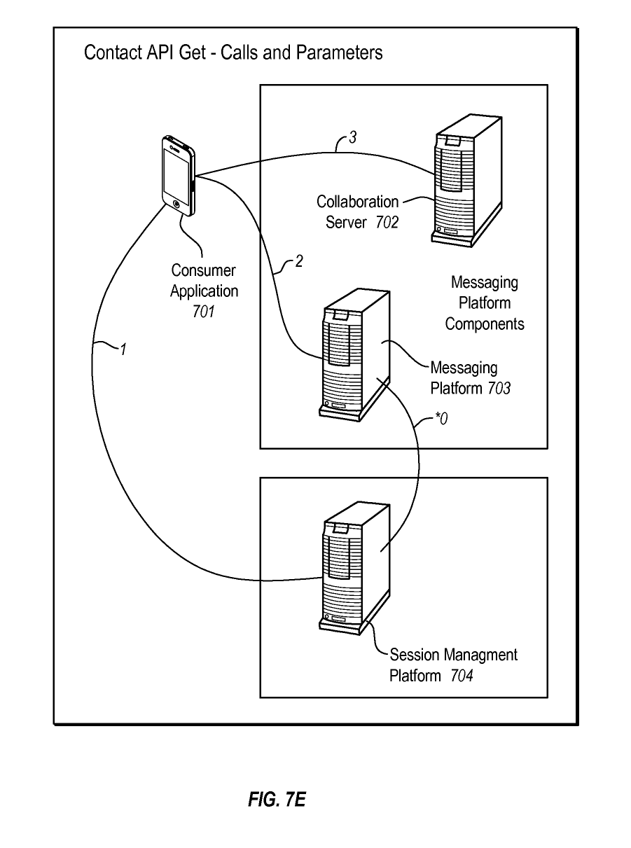

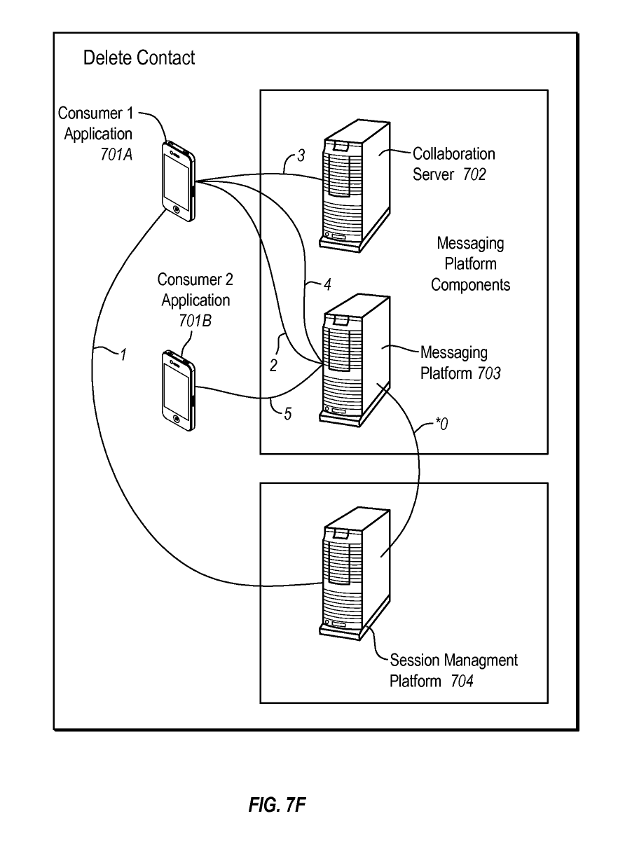

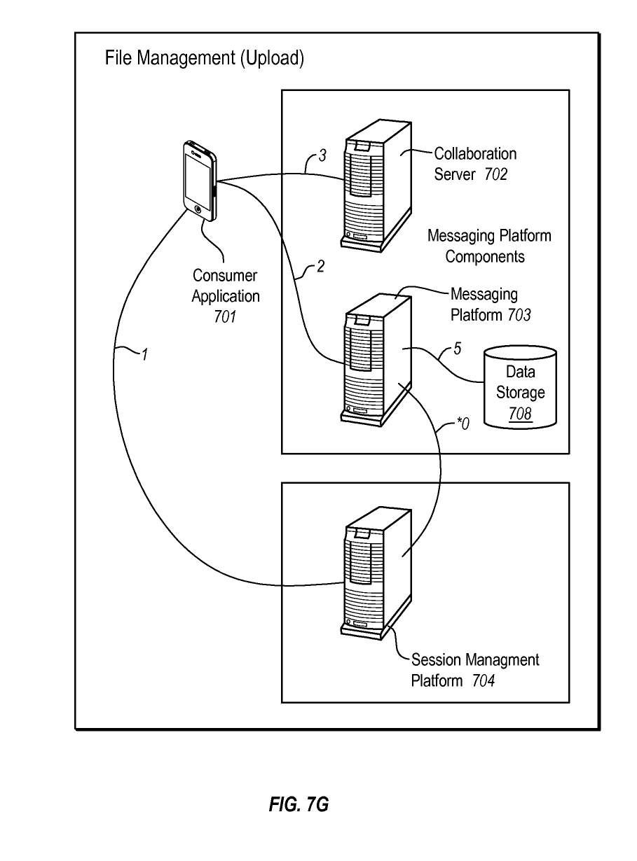

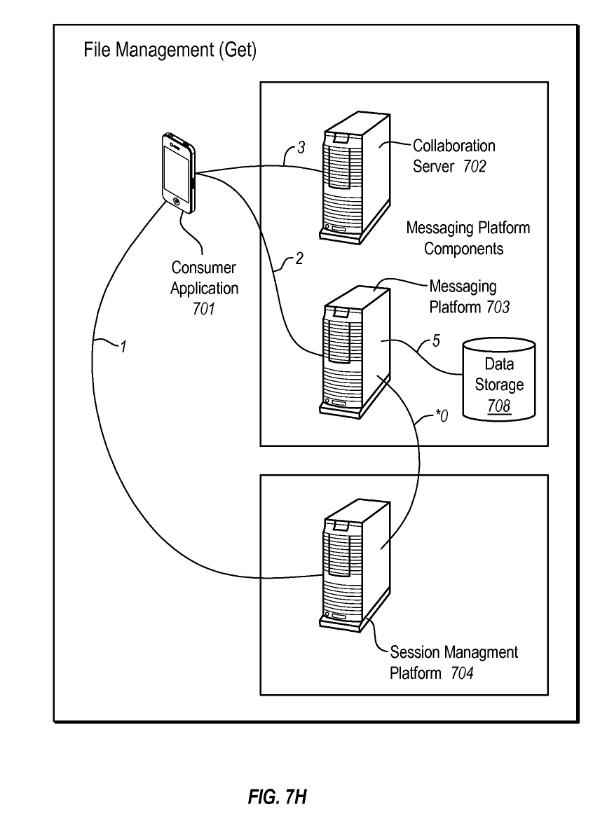

As can be seen, each mobile application in the platform 601 (i.e. applications 603 and 609) may have different messaging components (604 and 610, respectively). Application 603 has specific UI components, while application 609 has XMPP library components, one-time password (OTP) library components for secured chat, encrypted storage components for storing the chat history in an encrypted manner, as well as UI components. These messaging components 604 and 610 may be the same as the additional functionality modules 110 shown in FIG. 1. Each application may interact directly with the application server 605 and/or the tools server 611 and/or the database server 615 or storage 607. The XMPP server 612 may provide various chat functionality including an authentication plugin 613 and an offline messages plugin 614. The database server 615 may include a messaging platform database 616 that stores contacts and other data, and/or a collaboration database 617 that stores account information and chat-related storage. Various functionality and component interactions will be described further with regard to FIGS. 7A-7H.

FIG. 7A illustrates a messaging platform that validates calls from clients on a session management platform 704 (at 0*). Typically, each operation on the messaging platform 703 implements a session token. At (1) The consumer application 701 makes a call to the session platform 704 to get a mutual session token. The session management platform returns a session token. The messaging component on the consumer application 701 registers with the messaging platform 703 at (2). The messaging application 701 sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token.

FIG. 7B illustrates an embodiment for retail messaging. At (0*), a messaging platform 703 validates calls from clients that are using the session management platform 704. Typically, each operation on the messaging platform 703 implements a session token. The consumer application 701 makes a call to the session management platform 704 to get a session token. The session management platform 704 returns the session token at (1). The messaging component from the consumer application registers on the messaging platform 703 at (2). The consumer application 701 sends the following to the platform: a meted session token, an indication of device OS type (e.g. iOS or Android), a device notification token, and a tenant name. The messaging platform 703 returns information about the session management platform 704 which will be used and a messaging user ID. The consumer application 701 then opens an XMPP connection with a collaboration server 702 using a messaging user ID and session token at (3).

If a user wants to send a retail message with a file to tenant users, the retail user signs on to the session management platform 704 at the retail portal 709. The session management platform 704 then returns a session token at (4A). At (4B), the user uploads the file to the messaging platform 703 by using a file upload API from the messaging platform. At (4C), the messaging platform uploads this file to cloud data storage 708, and returns the file ID back to the consumer application. At (5), the consumer application calls a retail API from the messaging platform 703 to send a retail message. The consumer application 701 also passes file IDs that will be sent with the retail message.

At (5B), the messaging platform 703 generates retail messaging delivery jobs and put them to the queue on message broker server 707. At (5C), when the consumer application performs this job, it is sending the message directly to the user using a collaboration server 702 API. At (5D), the collaboration server checks if the user is online and, if the message can be delivered through XMPP, it delivers messages to users through XMPP. The collaboration server 702 then detects that the user is offline (at 5E), and sends a push notification message to a push notification server 706. The push notification server 706 delivers the push notification message to the user's device at (5F). At (6A), the consumer application 701 sends a request for the file content to the messaging platform using the file ID if the message contains files. At (6B), the messaging platform 703 reads the file from the cloud storage 708 and returns it to the consumer application 701.

FIG. 7C illustrates an embodiment in which a contact is added to the messaging platform 703. At (0*), the messaging platform 703 validates calls from clients on the session management platform 704. Typically, operations of the messaging platform API implement a session token. At (1), the consumer application 701A makes a call to the session management platform 704 to get a session token. The session management platform 704 then returns session token. At (2), a messaging component on the consumer application 701A makes a registration request on the messaging platform 703. The messaging application 701A sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token

When the user wants to approve an incoming contact request, the user of consumer application 701A sends a request for adding another user (e.g. the user of consumer application 701B) to the messaging platform 703 (at (4)). The messaging platform checks to determine if there is already a request with the same credentials. If yes, the platform returns a code indicating such as a response. If no, the messaging platform 703 determines whether an appropriate account is in the database and (if found) creates a contact request which will be sent to consumer application 701B and saved in the database with status “pending”. At (5), the contact request is sent to the consumer application 701B. As soon as both users are updated, a new contact request will be added to their fields of incoming contact requests and outgoing contact requests.

FIG. 7D illustrates an embodiment in which contacts are approved using the mobile messaging platform. At (0*), a messaging platform 703 validates calls from clients on a session management platform 704. Typically, each operation on the messaging platform 703 implements a session token. At (1) The consumer application 701 makes a call to the session platform 704 to get a mutual session token. The session management platform returns a session token. The messaging component on the consumer application 701 registers with the messaging platform 703 at (2). The messaging application 701 sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token.

At (4), the user of the second consumer application 701B approves the request from the user of consumer application 701A, such that user 701B's user ID and session token along with the contact request affirmation are sent to the messaging platform 703. At (5), the messaging platform 703 changes the contact request status from “pending” to “approved” and updates both users to modify their contact lists. Then the messaging platform notifies consumer application 701A about the fact its contact request was approved by the user of the second consumer application 701B.

FIG. 7E illustrates an embodiment in which contacts are retrieved using the mobile messaging platform. At (0*), a messaging platform 703 validates calls from clients on a session management platform 704. Typically, each operation on the messaging platform 703 implements a session token. At (1) The consumer application 701 makes a call to the session platform 704 to get a mutual session token. The session management platform returns a session token. The messaging component on the consumer application 701 registers with the messaging platform 703 at (2). The messaging application 701 sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token.

At (4), the data about each of the contacts from the contacts field of the user is taken from the messaging platform database 703 and returned to the messaging application in the form of user ID, credential, first name, last name, type “contact”. If there are any incoming contact requests for the user with status “pending’, they are sent in the same list in the form of user ID, credential, first name, last name, type “Incomingrequest”. If there are any outgoing contact requests, only their credential and type “outgoingrequest” are also sent in the same list back to the mobile messaging application 701 of the user. As such, the user's contact list is updated after login.

FIG. 7F illustrates an embodiment in which contacts are deleted using the mobile messaging platform. At (0*), a messaging platform 703 validates calls from clients on a session management platform 704. Typically, each operation on the messaging platform 703 implements a session token. At (1) The consumer application 701 makes a call to the session platform 704 to get a mutual session token. The session management platform returns a session token. The messaging component on the consumer application 701 registers with the messaging platform 703 at (2). The messaging application 701 sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token.

At (4), the user of consumer application 701A removes the user of consumer application 701B from his or her contact list in the mobile application. The request goes to the messaging platform 703 which updates the information in the database. At this point, the user of consumer application 701A does not have the user of consumer application 701B in the contact list. At (5), the message is sent by the messaging platform 703 to the user of consumer application 701B notifying the user about being removed from the contact list of the user of consumer application 701A.

FIG. 7G illustrates an embodiment in which files are uploaded and/or managed using the mobile messaging platform. At (0*), a messaging platform 703 validates calls from clients on a session management platform 704. Typically, each operation on the messaging platform 703 implements a session token. At (1) The consumer application 701 makes a call to the session platform 704 to get a mutual session token. The session management platform returns a session token. The messaging component on the consumer application 701 registers with the messaging platform 703 at (2). The messaging application 701 sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token.

At (4), the user can begin uploading files to cloud storage (or to another perhaps local data store) using the file as an attachment in the message. The file is sent to the messaging platform 703. If successful, a new file ID is returned to the consumer application 701. At (5), the messaging platform 703 forms and saves a link to the file and sends the link to cloud data storage 708 as binary stream.

FIG. 7H illustrates an embodiment in which files are accessed using the mobile messaging platform. At (0*), a messaging platform 703 validates calls from clients on a session management platform 704. Typically, each operation on the messaging platform 703 implements a session token. At (1) The consumer application 701 makes a call to the session platform 704 to get a mutual session token. The session management platform returns a session token. The messaging component on the consumer application 701 registers with the messaging platform 703 at (2). The messaging application 701 sends a session token, a device OS type (e.g. iOS or Android), a device notification token, and a tenant name to the messaging platform 703. The messaging platform 703 returns the information about a collaboration server 702 which will be used and the user's ID to the consumer application 701. The consumer application opens an XMPP connection with the collaboration server 702 using the user ID and the session token.

At (4), the user accesses a previously uploaded file from the cloud storage 708. The file is requested using its file ID. At (5) the messaging platform 703 sends the link to the file to the cloud storage 708 which returns the file to the platform in form of binary stream. After step (5), the user of consumer application 701 may download the file to the device or attach the file to a message using the file ID.

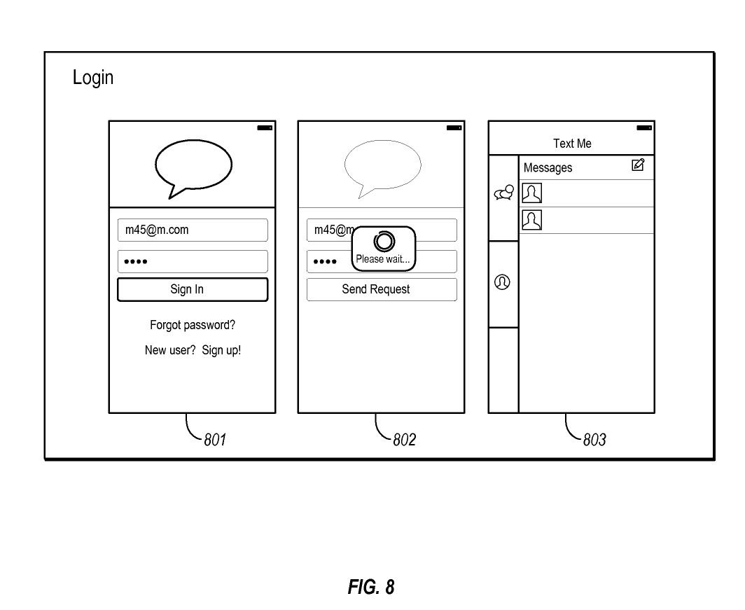

Turning now to FIGS. 8-16, a series of example user interface (UI) wire frames are depicted to provide general implementation ideas. It will be understood, of course, that these wire frames are only examples of possible implementations, and that other wire frames may be used to accomplish the same or different types of functionality.

FIG. 8 illustrates three images 801, 802 and 803 related to logging a registered user into the messaging platform that is generally shown in FIGS. 1 and 6. To login, the user may enter their credentials (e.g. identifier and password, or biometric credentials) to the appropriate fields in the authorization window of the Application and push “Sign In” (as shown in 801). In 802, the wire frame indicates that the user is being logged in, and in 803, the user is logged in and shown the main application screen.

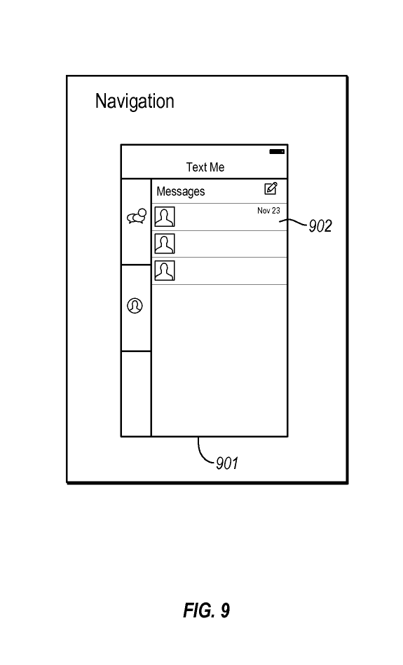

After registration and getting to the contact list, it is possible to change the view to a message screen or to profile settings, among other views. To enter the message screen, the user may touch the picture with two caption clouds at the top of the navigation panel. To enter the profile settings, the user may push the gear symbol at the bottom of the navigation panel. Staying on the message screen, the user can see the list of the received messages along with the date and first words of the last message from each contact. New messages are shown at the top of the list. Being unread, such messages may be marked with an orange dot (or otherwise designated) near the name of the contact. It may be possible to open chat history from this screen with a single touch to the name 902 of any displayed contact in the frame 901 of FIG. 9.

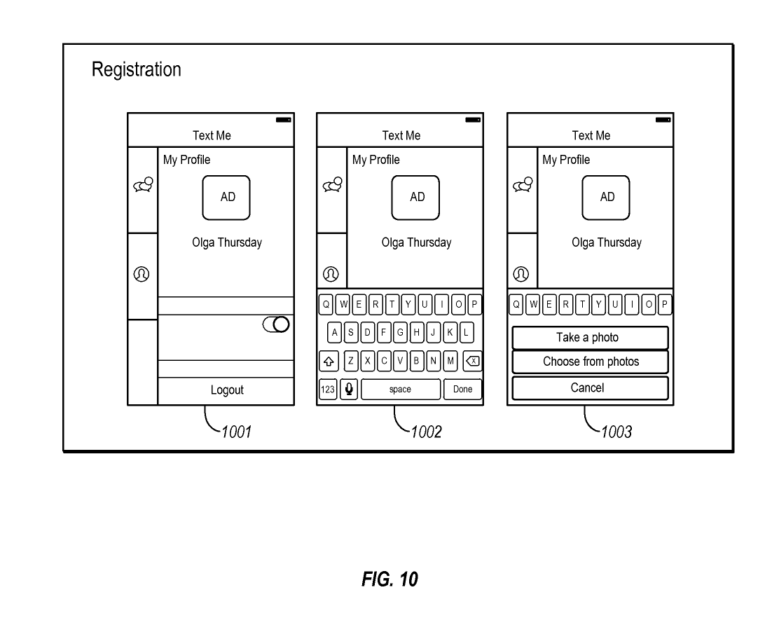

From this screen, the user may view the profile or perform a logout with the help of the appropriate buttons: “Profile” and “Logout” (or “Log out”). Choosing the first option, the user is taken to the profile screen where it is possible to set up or change the user's avatar (as shown in 1001 and 1002 of FIG. 10). To do it, use the pen symbol located in the lower right corner of the contact icon. In this embodiment, there may be two ways of completing this operation: taking photo via device camera (as shown in 1003 of FIG. 10) or choosing an already existing picture from the gadget gallery. Choosing the logout option, the user leaves the messaging application. The user may continue to receive offline notifications about new messages even after being logged out.

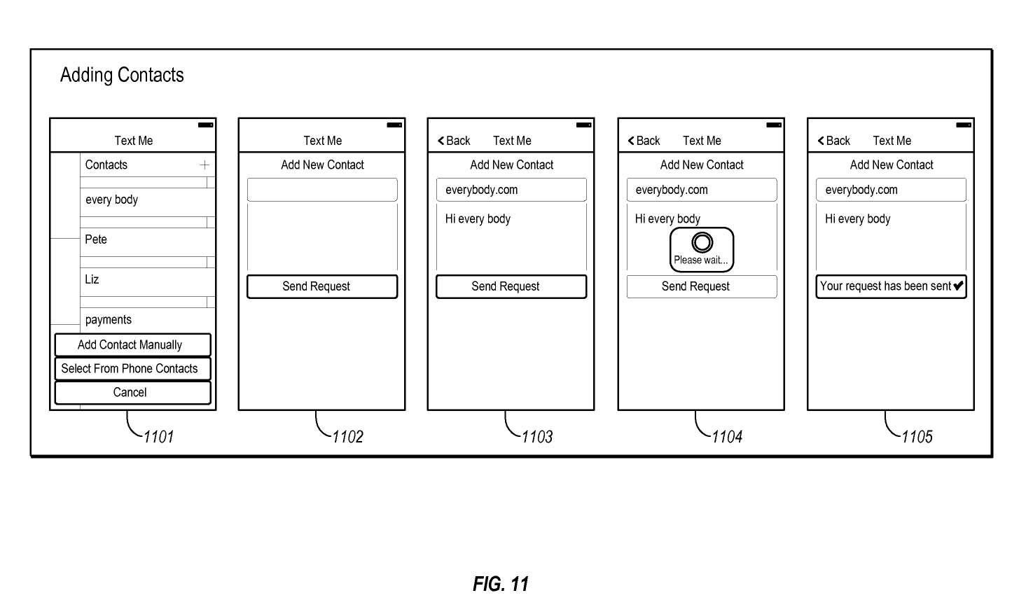

Contacts may be added as shown in FIG. 11. Contacts may be added in at least two ways. The user may start this process by pushing the plus symbol on the right side of the top of their contact list (1101) and then either type the user's credential manually (1102 & 1103) or search for it in the phone list of the device (1104 & 1105). In some cases, it may be possible to attach a text message to the contact request. When the data requested of the user is entered into the field(s), the user can use the “Send Request” button (shown in 1102 & 1103) to finish the operation. In the end, it may be possible to continue adding new contacts performing the above steps again for each user that is to be added.

When another user sends a contact request to you, it is displayed in the contact list of the messaging application. If the user wants to approve an incoming contact request, the user may select use the tick symbol. This selection will lead to adding the user to the contact list or vice versa (i.e. the user will be added to his or her contact list as well. After that, the user will be allowed to chat with each other and to add each other to group conversations. If the user, for some reason, does not want to accept the incoming contact request, the user can select the “Decline” button or the diagonal cross symbol to reject the request which will immediately disappear from the screen.

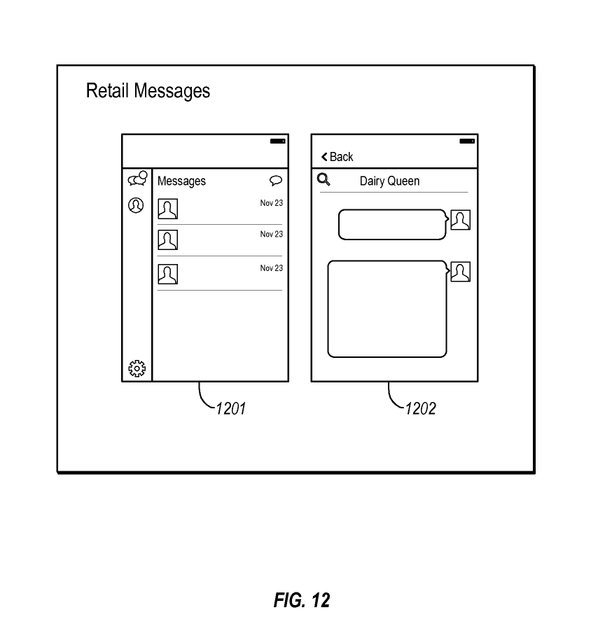

To send a retail message, a user may select a retail API column, and use a “send message” option to create and send the message. There it is possible to send either an ordinary message typing it in a retail message parameter field or to add attachments and customize the lifetime of the message prior to the delivery. When the user receives a retail message, the contact of the sender appears at the top of their contact list along with the first words of the message. Online users may have an extra border around their contact icons in the chat to mark them out and make it easier for you to navigate in the contact list (as shown in 1201 of FIG. 12). To see the whole message, the user may select its line with a single touch (as shown in 1202 of FIG. 12).

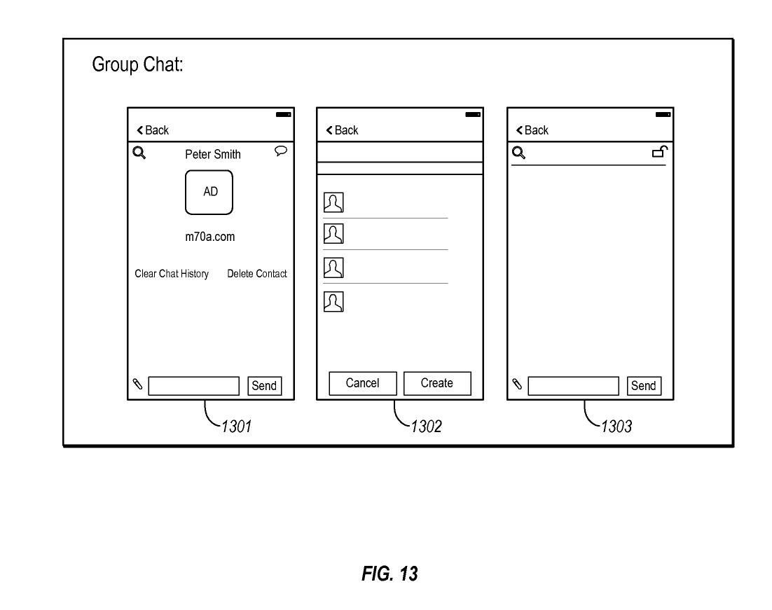

To create a group chat, the user may select a button (e.g. marked with an outline frame in 1301 of FIG. 13) either from a specific contact profile or from the list of messages. In the first case, the contact is added to the members automatically. The user then chooses all contacts that they want to add to the chat room (as shown in 1302 of FIG. 13). The user may enter the name of the group (optional) and finish the process of creating a new chat with the help of “Create” function (see 1302). To stop the process of making the group chat, push “Cancel” and it will bring the user back to the window from which the creating of the chat was started (1303).

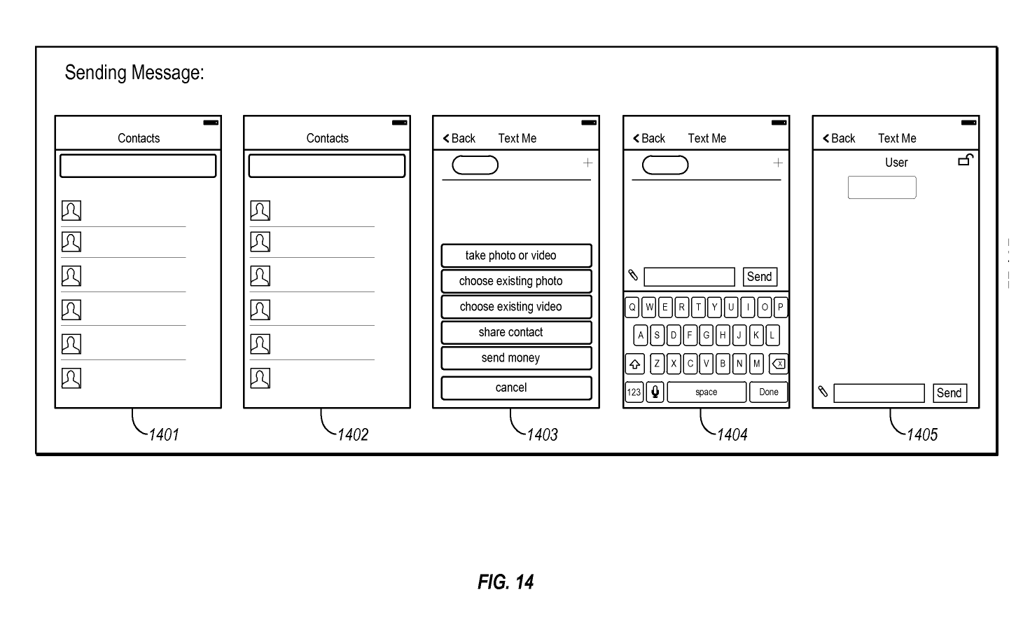

To send a message to another user, the user may select the user in their contact list with a single touch (see 1401 & 1402 of FIG. 14). It may be possible to choose several users to receive the message simultaneously. The user may type the text in a line at the bottom of the screen. When the message is written, push “Send”. If the user wants to attach a file to their message, the user may push a round button with a clip symbol on it which is located leftwards in the chat line (1404). Then the user selects the type of the attachment from the list of suggested variants (1403). To add several attachments to the message, perform the previous step as many times as it's needed, and then hit send to send the message. Being sent, each of your messages is displayed in the chat history in a white cloud with a small arrow on the left side (1405). The design of the interface may have some insignificant differences depending on the software platform of the device.

When somebody sends a message to the user, his or her contact record goes to the top position in your contact list and stays there until the user receives a new messages from other contacts. Each received message may be shown in the chat history inside a grey cloud with a small arrow pointing to the left. The user can also answer the messages received from other users through standard chat tools in the bottom of the screen.

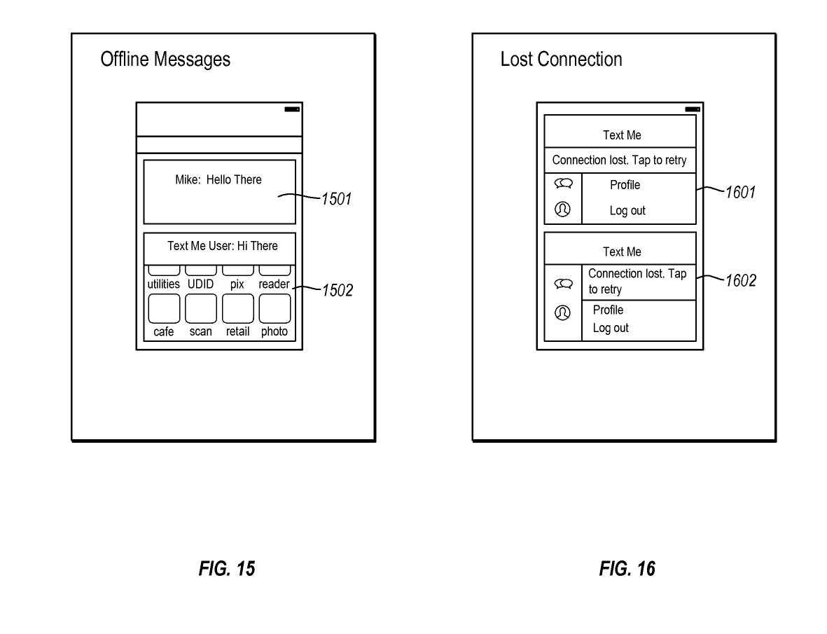

Being logged out, the user may still be able to receive messages via special plugin for push notifications. This messages may be shown in a narrow line on the top of your screen as shown in 1501 & 1502 of FIG. 15, where the name of the sender and partially the message itself are displayed. In cases where the application has lost its internet connection, the messaging application may inform the user about this problem with a special message asking to retry the connection (see 1601 & 1602 of FIG. 16). The user can tap on the message to confirm the reconnection attempt. In this manner, many different types of functionality may be added to a modular messaging application to send messages.

Accordingly, methods, systems and computer program products are provided which provide a modular messaging platform that accommodates additional functionality modules, which may be user- or industry-specific.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer program product for implementing a method for providing a modular messaging platform that accommodates additional functionality modules, the computer program product comprising one or more computer-readable storage media having stored thereon computer-executable instructions that, when executed by one or more processors of a computing system, cause the computing system to perform the method, the method comprising:
instantiating a modular messaging application that is configured to interoperate with one or more additional functionality modules, the additional functionality modules being configured to provide some portion of additional functionality to the modular messaging application;
receiving an indication indicating that at least one specified additional functionality module is to be implemented within the modular messaging application; and
initiating transmission of a message from the messaging application, the message being sent using at least a portion of the functionality provided by the additional functionality module.

2. The computer program product of claim 1, wherein the portion of additional functionality comprises encryption.

3. The computer program product of claim 1, wherein the portion of additional functionality comprises attaching files.

4. The computer program product of claim 1, wherein the portion of additional functionality comprises causing the message to automatically perish after a specified period of time or after a specified set of one or more actions.

5. The computer program product of claim 1, wherein the portion of additional functionality comprises group chat functionality that allows users to chat with one or more other users in a chat session instantiated by the modular messaging application.

6. The computer program product of claim 1, wherein the portion of additional functionality comprises contact management functionality that allows users to manage contacts from within the modular messaging application.

7. The computer program product of claim 1, wherein the modular messaging application includes business functionality layers, the business functionality layers comprising one or more additional functionality modules.

8. The computer program product of claim 7, wherein the business functionality layers are user-customizable.

9. The computer program product of claim 7, wherein the one or more additional functionality modules in each business functionality layer are user-customizable.

10. The computer program product of claim 7, wherein a plurality of business functionality layers are implemented on top of the messaging application.

11. The computer program product of claim 7, wherein the business functionality layers are industry-specific.

12. The computer program product of claim 11, wherein the industry-specific business functionality layers include industry-specific additional functionality modules that include pre-generated instructions addable to the modular messaging application.

13. The computer program product of claim 11, wherein the industry-specific business functionality layers of the modular messaging application are configurable to ensure compliance with industry-specific regulatory requirements.

14. At a computer system including at least one processor and a memory, a computer-implemented method for providing a modular messaging platform that accommodates additional functionality modules, the method comprising:
instantiating a modular messaging application that is configured to interoperate with one or more additional functionality modules, the additional functionality modules being configured to provide some portion of additional functionality to the modular messaging application;
receiving an indication indicating that at least one specified additional functionality module is to be implemented within the modular messaging application; and
initiating transmission of a message from the messaging application, the message being sent using at least a portion of the functionality provided by the additional functionality module.

15. The method of claim 14, wherein the modular messaging application includes business functionality layers, the business functionality layers comprising one or more additional functionality modules.

16. The method of claim 15, wherein the business functionality layers and the one or more additional functionality modules in each business functionality layer are user-customizable.

17. The method of claim 15, wherein a plurality of business functionality layers are implemented on top of the messaging application, the business functionality layers being industry-specific, the industry-specific business functionality layers including industry-specific additional functionality modules that themselves include pre-generated instructions addable to the modular messaging application.

18. The method of claim 17, wherein the industry-specific business functionality layers of the modular messaging application are configurable to ensure compliance with industry-specific regulatory requirements.

19. A computer system comprising the following:
one or more processors;
an application instantiating module for instantiating a modular messaging application that is configured to interoperate with one or more additional functionality modules, the additional functionality modules being configured to provide some portion of additional functionality to the modular messaging application;
a receiving module for receiving an indication indicating that at least one specified additional functionality module is to be implemented within the modular messaging application; and
a transmission initiating module initiating transmission of a message from the messaging application, the message being sent using at least a portion of the functionality provided by the additional functionality module.

20. The computer system of claim 18, wherein the additional functionality is applied according to at least one functionality module implementation policy.
